(19) United States
(12) Patent Application Publication
(10) Pub. No.: US 2025/0215261 A1
(43) Pub. Date: Jul. 3, 2025

(54) POROUS FILM, METHOD OF MANUFACTURING POROUS FILM, AND STRUCTURE

(71) Applicant: Sony Group Corporation, Tokyo (JP)

(72) Inventor: Shigeru SAKAMOTO, Tokyo (JP)

(21) Appl. No.: 18/850,835

(22) PCT Filed: May 17, 2023
(86) PCT No.: PCT/JP2023/018490

§ 371 Date: Sep. 25, 2024

(30) Foreign Application Priority Data
Jul. 5, 2022 (JP) 2022-108615

(51) Int. Cl. C09D 183/16; B82Y 40/00; C09D 5/20

(52) U.S. Cl. CPC C09D 183/16; B82Y 40/00; C09D 5/20

(57) ABSTRACT

A nanomaterial structure is provided and includes a nanomaterial including a nanomaterial surface; an organic silane compound provided on the nanomaterial surface; and a nanomaterial cross-linking part, wherein the nanomaterial is cross-linked with the nanomaterial cross-linking part.

### CROSS REFERENCE TO RELATED APPLICATIONS

This application claims the benefit of Japanese Priority Patent Application JP2022-108615 filed Jul. 5, 2022, the entire contents of which are incorporated herein by reference.

### TECHNICAL FIELD

The present disclosure relates to a water-repellent porous film or porous material including a nanomaterial, such as, a nanoparticle, a nanofiber, a nanosheet or other nanomaterial of suitable size and shape, a method of manufacturing the porous film or porous material, and a structure, for example.

### BACKGROUND ART

For example, PTL 1 discloses a silica aerogel having water repellency and oil repellency and having a density in a range of 0.005 g/cc to 0.5 g/cc. The silica aerogel has a silica surface which has been subjected to fluorine treatment by chemically reacting, with a gel-like compound of silica having a skeleton of (SiO₂)ₘ (m is a positive integer) and including a silanol group, a fluoroalkyl silane compound including both a fluoroalkyl group and a functional group being able to react with a silanol group.

### CITATION LIST

### Patent Literature

[PTL 1] Japanese Unexamined Patent Application Publication No. 2001-72408

### SUMMARY

### Technical Problem

A water-repellent nanomaterial structure including a nanomaterial (e.g., porous film or porous material) is desired, for example, to have improved light-transmittance.

It is desirable, for example, to provide a nanomaterial structure including a nanomaterial (e.g., porous film or porous material) having high light transmittance and water repellency, and a method of manufacturing the nanomaterial and the nanomaterial structure.

### Solution to Problem

The present disclosure relates to a nanomaterial technology.

In an embodiment, a nanomaterial structure is provided. The nanomaterial structure includes a nanomaterial including a nanomaterial surface; an organic silane compound provided on the nanomaterial surface; and a nanomaterial cross-linking part, wherein the nanomaterial coated is cross-linked with the nanomaterial cross-linking part.

A porous film or porous material, in an embodiment, is provided and including a nanomaterial including a nanomaterial surface; an organic silane compound provided on the nanomaterial surface; and a nanomaterial cross-linking part, wherein the nanomaterial is cross-linked with the nanomaterial cross-linking part.

In an embodiment, a method of manufacturing a nanomaterial structure is provided. The method includes providing a nanomaterial including a nanomaterial surface; and providing an organic silane compound on the nanomaterial surface to form a coated nanomaterial. In a further embodiment, a method includes providing a cross-linking agent; and forming a nanomaterial cross-linked structure by cross-linking a coated nanomaterial with the cross-linking agent. In a further embodiment, a method includes drying a nanomaterial cross-linked structure. In a further embodiment, a method includes forming a porous film or a porous material from a nanomaterial cross-linked structure. In a further embodiment, a method includes forming a product from a nanomaterial cross-linked structure.

### BRIEF DESCRIPTION OF DRAWINGS

FIG. 1 is a schematic view of an example of an outline configuration of a porous film according to an embodiment of the present disclosure.

FIG. 2A is a schematic view of an example of a structure of a nanoparticle illustrated in FIG. 1.

FIG. 2B is a schematic view of another example of the structure of the nanoparticle illustrated in FIG. 1.

FIG. 3 is a characteristic diagram illustrating a relationship between transmittance and a particle diameter of the porous film illustrated in FIG. 1.

FIG. 4 is an image diagram of a porous film of the present embodiment upon being photographed using a transmission electron microscope.

FIG. 5A is a schematic view of an example of an aspect of coupling between nanoparticles in a case of using the nanoparticle illustrated in FIG. 2A.

FIG. 5B is a schematic view of another example of the aspect of coupling between nanoparticles in a case of using the nanoparticle illustrated in FIG. 2B.

FIG. 6A is an explanatory schematic view of conditions of a cross-linking part in which nanoparticles coupled to each other do not aggregate.

FIG. 6B is an explanatory schematic view of conditions of a cross-linking part in which nanoparticles coupled to each other do not aggregate.

FIG. 7 is a flowchart illustrating manufacturing steps of the porous film illustrated in FIG. 1.

FIG. 8 is a schematic view of an example of an outline configuration of a porous film according to a modification example of the present disclosure.

FIG. 9 is a schematic view of another example of the outline configuration of the porous film according to the modification example of the present disclosure.

### DESCRIPTION OF EMBODIMENTS

In the following, description is given in detail of embodiments of the present technology with reference to the drawings. The following description is merely a specific example of the present disclosure, and the present disclosure should not be limited to the following aspects. Moreover, the present disclosure is not limited to arrangements, dimensions, dimensional ratios, and the like of each component illustrated in the drawings. It is to be noted that the description is given in the following order.

1. An embodiment (An example of a water-repellent porous film including a plurality of nanoparticles coupled to each other via a cross-linking part)

1-1. Configuration of Porous Film

1-2. Method of Manufacturing Porous Film

1-3. Workings and Effects

2. Modification Example (Another Example of Porous Film)

### 1. Embodiment

### (1-1. Configuration of Porous Film)

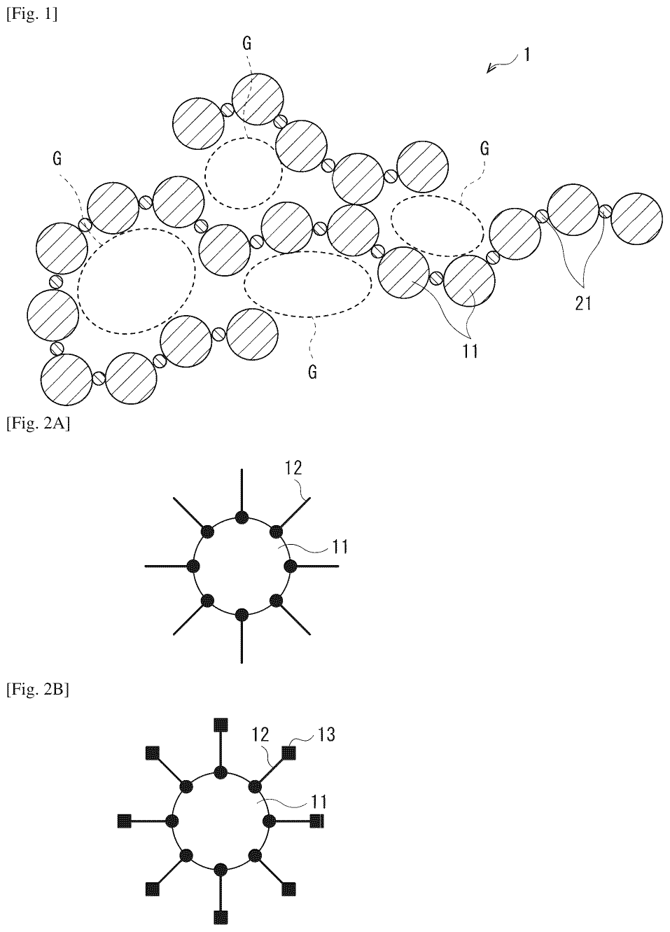

FIG. 1 schematically illustrates an example of a configuration of a porous film (a porous film 1) according to an embodiment of the present disclosure. The porous film 1 is used, for example, as an antireflection film and a protective sheet for anti-drip, anti-fouling, and anti-rust, as well as preventing adhesion of fingerprints, imparting lubricity, and maintaining a texture of a material. The porous film 1 of the present embodiment includes an organic silane molecule 12 (FIG. 2A) including an organic functional group or a fluoro group, or an organic functional group or a fluoro group. In the porous film 1, a plurality of nanoparticles 11, that are surface-coated with the organic silane molecule 12 further including a reactive functional group 13 (FIG. 2B), are coupled to each other via a cross-linking part 21.

The nanoparticle 11 is, for example, a silica particle. The nanoparticle 11 is surface-deactivated by reacting with the organic silane molecule 12 including an organic functional group or a fluoro group, for example, as illustrated in FIG. 2A. Alternatively, the nanoparticle 11 is surface-deactivated by reacting with the organic silane molecule 12 including an organic functional group or a fluoro group and further including the reactive functional group 13, for example, as illustrated in FIG. 2B. This brings the plurality of nanoparticles 11 into a state of not being able to be covalently bonded to each other.

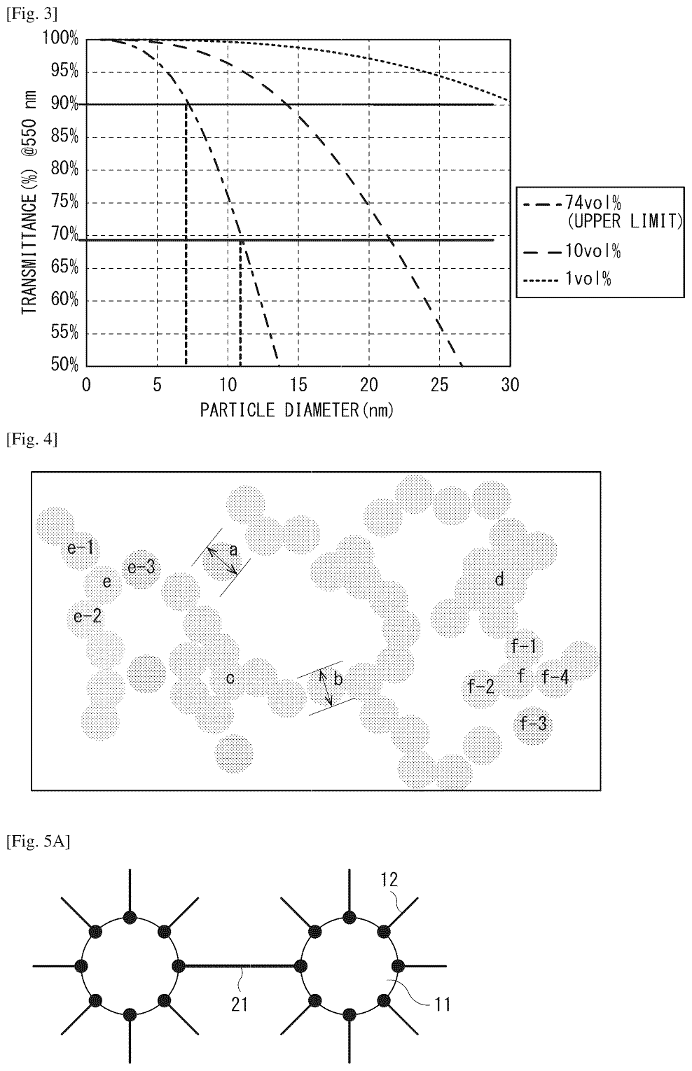

The thickness of a beaded skeleton forming the porous film 1 affects transparency (light transmittance) of the porous film 1. The thickness of the skeleton corresponds to the particle diameter of the nanoparticle 11; a thinner skeleton causes light to be less scattered, thus improving the transparency. The average particle diameter (median diameter) of the nanoparticle 11 is preferably, for example, a diameter of 11 nm or less, and more preferably a diameter of 7 nm or less. Thus, for example, as illustrated in FIG. 3, in a case where the plurality of nanoparticles 11 inside the porous film 1 has a closest-packed structure, it is possible to obtain a light transmittance of 70% or more, or a light transmittance of 90% or more equivalent to that of glass or plastic.

The average particle diameter (median diameter) of the nanoparticle 11 is determined as follows. First, the porous film 1 as a measurement target is subjected to working by a Focused Ion Beam (FIB) method or the like to perform thinning. In a case where the FIB method is used, a carbon film and a tungsten thin film are formed as protective films, as a treatment prior to observing a transmission electron microscope (TEM) image of a cross-section described later. The carbon film is formed on a surface of the porous film 1 by a vapor deposition method. The tungsten thin film is formed on the surface of the porous film 1 by a vapor deposition method or a sputtering method. This allows for formation of the cross-section of the porous film 1 by the thinning.

The cross-section of an obtained thinned sample is subjected to cross-sectional observation using a transmission electron microscope (Tecnai G2 manufactured by FEI Ltd.) to enable the plurality of nanoparticles 11 to be observed at an acceleration voltage of 200 kV and at a field of view of 50 nm·˜50 nm, whereby a TEM photograph is taken. It is assumed that the photographing position is selected at random from the thinned sample.

Next, 50 nanoparticles 11, of which diameters can be clearly confirmed in a direction of an observation surface, are selected from the taken TEM photograph. When the number of the nanoparticles 11, of which the diameters can be clearly confirmed, present inside photographed one field of view is less than 50, 50 nanoparticles 11, of which the diameters can be clearly confirmed in the direction of the observation surface, are selected from a plurality of fields of view. FIG. 4 is an image diagram of the TEM photograph of the porous film 1 taken using a transmission electron microscope. For example, in FIG. 4, a nanoparticle a and a nanoparticle b, of which diameters can be clearly confirmed, are selected. Meanwhile, for example, as for a nanoparticle c and a nanoparticle d, the nanoparticles 11 overlap each other in a depth direction of observation and shapes thereof are not confirmable, and thus the nanoparticle c and the nanoparticle d are not suitable as measurement targets. The maximum diameter of each of the selected 50 nanoparticles 11 is measured.

Here, it is assumed that the maximum diameter is a maximum distance (so-called maximum Feret diameter) of distances between two parallel lines drawn from all angles to be tangent to the contour of the nanoparticle 11. In measuring the maximum diameter (maximum Feret diameter), the diameter of a particulate portion excluding a coated part (organic silane molecule 12) coating the surface of the nanoparticle 11 is measured. Determining a median of the 50 maximum diameters (maximum Feret diameters) thus determined allows for an average particle diameter (median diameter) of the nanoparticle 11.

As described above, the organic silane molecule 12 is used to deactivate the surfaces of the nanoparticles 11 in order to prevent bonding between the plurality of nanoparticles 11. The organic silane molecule 12 forms a covalent bond with the nanoparticle 11, and includes an organic functional group or a fluoro group. The nanoparticle 11 is surface-coated with the organic silane molecule 12 including an organic functional group or a fluoro group, thereby making the surface of the nanoparticle 11 water-repellent. In particular, coating the surface of the nanoparticle 11 with the organic silane molecule 12 including a fluoro group makes it possible to impart not only water repellency but also oil repellency.

Examples of the organic silane compound including an organic functional group or a fluoro group include the one represented by the following general formula (1) or general formula (2).

(Chemical Formula 1)

R¹ₓSi(OR²)_{4·|x}·c (1)

(Chemical Formula 2)

R¹ₓSiCl_{4·|x}·c (2)

(R¹ is any of a methyl group, an ethyl group, a propyl group, an isopropyl group, a butyl group, a pentyl group, a hexyl group, a heptyl group, an octyl group, a decyl group, a dodecyl group, a hexadecyl group, a vinyl group, a phenyl group, 1H,1H,2H,2H-tridecafluoro-n-octyl, 1H,1H,2H,2H-heptadecafluorodecyl, pentafluorophenyl, 1H,1H,2H,2H-nonafluorohexyl, 3-(2,3,4,5,6-pentafluorophenyl)propyl, 11-pentafluorophenoxyundecyl, and 5,5,6,6,7,7,7-heptafluoro-4,4-bis(trifluoromethyl)heptyl. R² is any of a methyl group, an ethyl group, a propyl group, and an isopropyl group. R² is any of a methyl group, an ethyl group, a propyl group, and an isopropyl group. X is an integer of 0 or 2 or less.)

It is to be noted that presence or absence of the organic silane molecule 12 coating the surface of the nanoparticle 11 and an aspect of the bonding between the nanoparticle 11 and the organic silane molecule 12 are able to be confirmed, for example, by component analysis or composition analysis. Examples of the component analysis and the composition analysis include Fourier transform infrared spectroscopy analysis (FT-IR), gas chromatography analysis (GC), X-ray photoelectron spectroscopy (XPS), nuclear magnetic resonance analysis (NMR), and energy-dispersive X-ray analysis (EDX). The presence or absence of the organic silane molecule 12 coating the surface of the nanoparticle 11 and the aspect of the boding between the nanoparticle 11 and the organic silane molecule 12 are able to be analyzed using one or a plurality of the above-mentioned analysis methods.

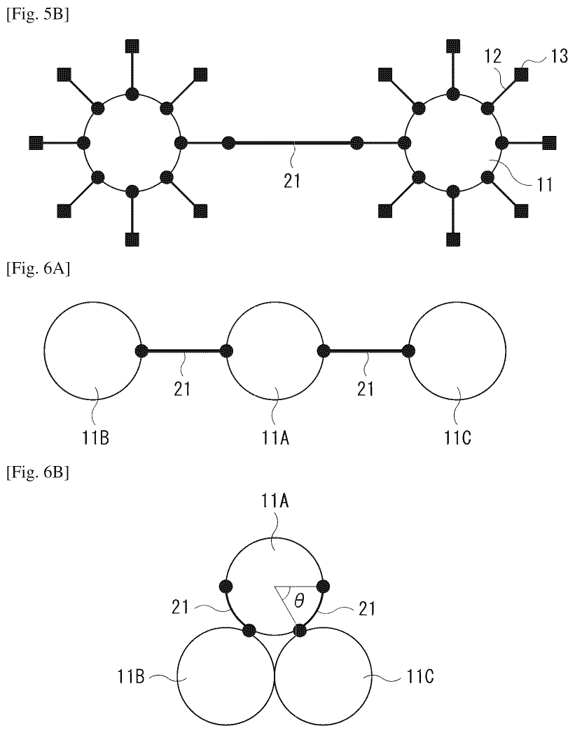

The cross-linking part 21 couples the plurality of nanoparticles 11 to each other as described above. Specifically, the cross-linking part 21 is an organic matter or an inorganic matter covalently bonded directly to the nanoparticle 11, for example, as illustrated in FIG. 5A. Alternatively, the cross-linking part 21 is an organic matter or an inorganic matter covalently bonded indirectly to the nanoparticle 11 via an organosilyl group (organic silane molecule 12), for example, as illustrated in FIG. 5B. The cross-linking part 21 forms a covalent bond with one or two nanoparticles 11.

The length of the cross-linking part 21 is preferably smaller than half (½) of the average particle diameter (diameter) of the nanoparticle 11, for example. Specifically, as illustrated in FIG. 6A, the length of the cross-linking part 21 is preferably a length at which a nanoparticle 11B and a nanoparticle 11C are not in contact with each other, in a state where the two nanoparticles 11B and 11C are coupled to one nanoparticle 11A at respective farthest positions (diagonal positions) via the cross-linking parts 21. That is, the length of the cross-linking part 21 is preferably less than a circumference of 60□<(=fÎ/6 of diameter) of the nanoparticle 11 (11A), as illustrated in FIG. 6B. This makes it possible to prevent aggregation of the plurality of nanoparticles 11 inside the porous film 1.

Examples of such a cross-linking part 21 include a cross-linking agent having two or more reactive points. Examples of a cross-linking agent that forms a covalent bond directly with the nanoparticle 11, among those mentioned above, include a silane compound represented by the following general formula (3), general formula (4), general formula (5), or general formula (6).

(Chemical Formula 3)

R³_{Y}Si (OR⁴)_{4·|Y}·c (3)

(Chemical Formula 4)

R³_{Y}SiCl_{4·|Y}·c (4)

(Chemical Formula 5)

(R⁴O)_{3·|Y}R³_{Y}Si—R⁵—SiR³_{Y}(OR⁴)_{3·|Y}·c (5)

(Chemical Formula 6)

Cl_{3·|Y}R³_{Y}Si—R⁵—SiR³_{Y}Cl_{3·|Y}·c (6)

(R³ is any of a hydrogen atom, a methyl group, an ethyl group, a propyl group, an isopropyl group, and a phenyl group. R⁴ is any of a methyl group, an ethyl group, a propyl group, and an isopropyl group. R⁵ is any of a methylene group, an ethylene group, a propylene group, a butylene group, a pentylene group, a hexylene group, and a phenylene group. Y is an integer of 0 or 2 or less).

Examples of a cross-linking agent covalently bonded indirectly to the nanoparticle 11 via an organosilyl group (organic silane molecule 12) include those including two or more reactive functional groups that react with the functional group of the organic silane molecule 12. Examples of such a cross-linking agent include polyfunctional allyl (vinyl), polyfunctional thiol, polyfunctional (meth) acrylate, and polyfunctional glycidyl.

Specific examples of the polyfunctional allyl (vinyl) include diallyl ether, diallyl sulfide, diallyl amine, diallyl adipate, diallyl dimethyl silane, diallyl isophthalate, diallyl urea, dimethyl divinyl silane, divinyl tetramethyl disiloxane, hexadiene, tetraallyloxyethane, triallyl cyanurate, and triallyl amine.

Specific examples of the polyfunctional thiol include ethanedithiol, propanedithiol, hexanedithiol, pentaerythritol tetrakis (mercaptoacetate), pentaerythritol tetrakis (3-mercaptobutyrate), 1,4-bis(3-mercaptobutyryloxy)butane, 1,3,5-tris(2-(3-sulfanylbutanoyloxy)ethyl)-1,3,5-triazinane-2,4,6 trione, and trimethylolpropane tris(3-mercaptobutyrate).

Specific examples of the polyfunctional (meth)acrylate include diethylene glycol dimethacrylate, ethylene glycol dimethacrylate, tetraethylene glycol diacrylate, diethylene glycol diacrylate, trimethylolpropane triacrylate, trimethylolpropane trimethacrylate, pentaerythritol tetraacrylate, and pentaerythritol tetramethacrylate.

Specific examples of the polyfunctional glycidyl include a glycidyl ether type epoxy resin such as bisphenol A diglycidyl ether, bisphenol F diglycidyl ether, or resorcinol diglycidyl ether, phthalic acid diglycidyl ester and dimer acid diglycidyl ester, triglycidyl ether triphenylmethane, tetraglycidyl ether tetraphenylethane, bisphenol S diglycidyl ether, cresol novolac glycidyl ether, triglycidyl isocyanurate, and tetrabrom bisphenol A diglycidyl ether.

An air gap G formed in the porous film 1 includes, for example, continuous fine pores.

The fine pore has an average pore diameter of several nm to several tens of nm, for example. This enables the porous film 1 to obtain a fine sponge-like bulk structure. It is to be noted that, although air is usually present inside the air gap G, the air gap G can be evacuated, or, for example, a gas, having a lower thermal conductivity than that of air, such as helium (He) or argon (Ar) can be encapsulated thereinto, thereby further lowering the thermal conductivity of the porous film 1.

In the porous film 1, for example, one to four or more nanoparticles 11 are closest to one nanoparticle 11. For example, in a case where four nanoparticles are closest to one nanoparticle 11 inside the porous film 1, the porous film 1 has a diamond structure, and a porosity thereof is 66% or more.

The number of the nanoparticles 11 closest to one nanoparticle 11 can be confirmed, for example, as follows. First, in the same manner as in the case of determining the average particle diameter (median diameter) of the nanoparticle 11 described above, the porous film 1 as a measurement target is subjected to working by a FIB method or the like to perform thinning. The cross-section of the obtained thinned sample is subjected to cross-sectional observation using a transmission electron microscope (Tecnai G2 manufactured by FEI Ltd.) to enable a plurality of nanoparticles 11 to be observed at an acceleration voltage of 200 kV and at a field of view of 50 nm·˜50 nm, whereby a TEM photograph is taken. It is assumed that the photographing position is selected at random from the thinned sample.

Next, 50 nanoparticles 11, of which diameters can be clearly confirmed in a direction of an observation surface, are selected from the taken TEM photograph. When the number of the nanoparticles 11, of which the diameters can be clearly confirmed in the direction of the observation surface, present within photographed one field of view is less than 50, 50 nanoparticles 11, of which the diameters can be clearly confirmed in the direction of the observation surface, are selected from a plurality of fields of view. For example, in FIG. 4, a nanoparticle e and a nanoparticle f, of which diameters can be clearly confirmed in the direction of the observation surface, are selected. Meanwhile, for example, as for the nanoparticle c and the nanoparticle d, particles overlap each other in a depth direction of observation and positions of the particles are not correctly confirmable, and thus the nanoparticle c and the nanoparticle d are not suitable as measurement targets.

For each of the selected 50 nanoparticles 11, the number of nanoparticles (e.g., nanoparticles e-1, e-2, and e-3 and nanoparticles f-1, f-2, f-3, and f-4) present at positions closer than a certain distance to a nano particle (e.g., nanoparticle e and nanoparticle f) is measured. It is assumed here that the certain distance is 0.5 times the diameter of the nanoparticle 11, which is the maximum value of the length of the cross-linking part 21. It is difficult to directly confirm the presence of the cross-linking part 21 because no image thereof is photographed by the electron microscope. However, in a case where the cross-linking part 21 is not present, it is not possible to maintain a structure in which the nanoparticles 11 are coupled to each other. Therefore, it can be considered that the cross-linking part 21 is present between the nanoparticle 11 and the nanoparticle 11. That is, the number of the nanoparticles 11 closest to one nanoparticle 11 corresponds to the number of the nanoparticles 11 bonded together via the cross-linking parts 21.

It is to be noted that the number of the nanoparticles 11 closest to one nanoparticle 11, i.e., the number of the nanoparticles 11 bonded via the cross-linking parts 21 refers to the number of other nanoparticles 11 bonded to the one nanoparticle 11 via the cross-linking parts 21. For example, in a case where certain one nanoparticle 11 is bonded to only another one nanoparticle 11 via a plurality of cross-linking parts 21, the number of the nanoparticle 11 bonded to the nanoparticle 11 via the cross-linking part 21 is one. The “number of the nanoparticles 11 closest to one nanoparticle 11” is obtained by determining the simple average (arithmetic average) of the numbers of other nanoparticles 11 bonded via the cross-linking parts 21 to the respective 50 nanoparticles 11 thus determined.

In addition, in a case where a component other than the nanoparticle 11 and the organic silane molecule 12 (silane coupling agent) coating the nanoparticle 11 is detected upon performing component analysis and composition analysis of the porous film 1 using the above-described FT-IR, GC, XPS, NMR and EDX, the component can be considered to be derived from the cross-linking part 21. Thus, it can be appreciated that the cross-linking part 21 including this component is present between the nanoparticles 11.

### (1-2. Method of Manufacturing Porous Film)

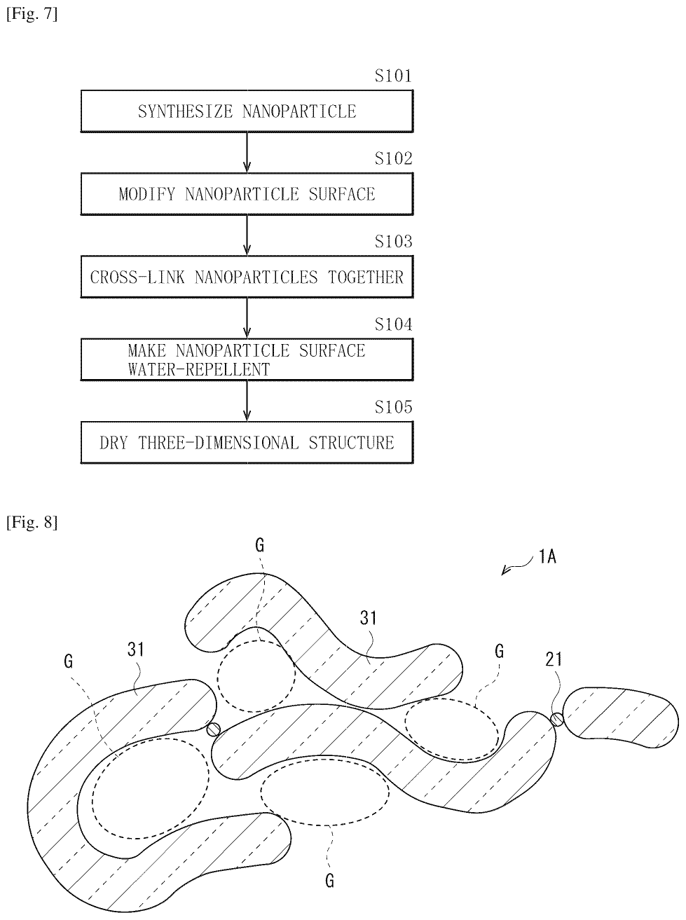

FIG. 7 illustrates a flowchart of manufacturing steps of the porous film 1. Hereinafter, description is given first of a method of manufacturing the porous film 1 in which a plurality of nanoparticles 11 are directly coupled to each other by the cross-linking parts 21.

### (Synthesis of Nanoparticle)

First, the nanoparticle 11 (e.g., silica particle) is synthesized using a liquid phase method (step S101). In general, a method of manufacturing silica nanoparticles is roughly classified into two types: a gas phase method and a liquid phase method. As described above, a fine nanoparticle 11 having a diameter of 11 nm or less is able to be isolated without causing aggregation by using the liquid phase method. It is preferable to select, as a precursor in the liquid phase method, a molecule represented by the following general formula (7), which is able to form a three-dimensional polysiloxane skeleton (Si—O—Si) through a hydrolysis reaction and a condensation polymerization reaction. Examples of such a precursor include water glass (silicate soda (sodium silicate)) and an alkoxysilane molecule. The alkoxysilane molecule may be a molecule, in which some of alkoxy groups are substituted with non-hydrolyzable functional groups, and is no obstacle to the formation of the polysiloxane skeleton.

(Chemical Formula 7)

R⁶_{Z}Si(OR⁷)_{4·|Z}·c (7)

(R⁶ is any of a methyl group, an ethyl group, a propyl group, an isopropyl group, a butyl group, a pentyl group, a hexyl group, a heptyl group, an octyl group, a decyl group, a dodecyl group, a hexadecyl group, a vinyl group, a phenyl group, an acryloxy group, a methacryloxy group, an aminopropyl group, a glycidoxypropyl group, and a mercaptopropyl group. R⁷ is any of a hydrogen atom, a methyl group, an ethyl group, a propyl group, and an isopropyl group. Z is an integer of 0 or 2 or less.)

After the above-described precursor is dissolved in water or an organic solvent, acidity or basicity is adjusted. Accordingly, silica particles are formed by a polymerization reaction. It is to be noted that, as long as the diameter of a final nanoparticle 11 is 11 nm or less, the method is not limited to the above-described manufacturing method. The followings are examples of reference literatures. For example, Literature 1 (T. Yokoi et al. Chem. Mater. 2009, 21, 3719-3729) reports formation of a nanoparticle having a diameter of 8 nm in an aqueous solution in the presence of an amino acid, in which the nanoparticle is surface-coated with an amino acid molecule, thereby enabling isolation of the nanoparticles without causing aggregation thereof. Literature 2 (S. Sakamoto et al. Langmuir 2018, 34, 1711-1717) reports formation of a nanoparticle having a diameter of 3 nm by using an inverted micellar liquid crystal phase as a template, in which the nanoparticle is surface-coated with surfactant molecules, thereby enabling isolation of the nanoparticles without causing aggregation thereof.

### (Surface Modification of Nanoparticle)

Next, the nanoparticles 11 are dispersed in a solvent to modify the surfaces (step S102). For example, an amphipathic molecule such as a surfactant molecule, an amino acid molecule, or a macromolecule such as a block copolymer of a phospholipid or polyalkylene glycol is added to a dispersion liquid in which the nanoparticles 11 are dispersed. The added amphipathic molecule is adsorbed on the surface of the nanoparticle 11 to serve to prevent the aggregation of the nanoparticles. As in the above-mentioned Literatures 1 and 2, depending on a manufacturing method, the nanoparticle 11 surface-coated with the amphipathic molecule is obtained. In such a case, the addition of the amphipathic molecule is omitted.

(Cross-Linking between Nanoparticles)

Subsequently, a cross-linking agent (silane compound) is used to cross-link the nanoparticles 11 together (step S103). The above-described silane compound having two or more reactive points is added as a cross-linking agent to the dispersion liquid in which the nanoparticles 11 are dispersed, with each surface being coated with a surfactant molecule, an amino acid molecule, a macromolecule, or the like. The amount of the silane compound to be added is not particularly limited. After the addition of the silane compound, the dispersion liquid is heated as needed. Thus, in the dispersion liquid, a cross-linking reaction of the nanoparticle 11 proceeds to form the porous film 1 having a three-dimensional structure. The dispersion liquid gradually loses its fluidity to be brought into a gel state.

### (Water Repellency of Nanoparticle Surface)

Next, the surface of the nanoparticle 11 is made to be water-repellent (step S104). The above-described organic silane compound including an organic functional group or a fluoro group is added to the dispersion liquid in which the nanoparticles 11 cross-linked by the cross-linking agent are dispersed. The amount of the organic silane compound to be added is not particularly limited. After the addition of the organic silane compound, the dispersion liquid is heated as needed. Thus, the surface of the nanoparticle 11 is made to be water-repellent.

### (Drying of Three-Dimensional Structure)

Finally, the dispersion liquid brought into a gel state is dried to obtain the porous film 1 (step S105). Examples of methods for drying and removing the solvent include drying at an elevated temperature under normal pressure. In a case where disintegration of the porous film 1 due to interfacial tension during drying is feared, it is preferable to use a supercritical drying method or a freeze-drying method. In the present embodiment, the surface of the nanoparticle 11 (silica particle), which is a cause of large interfacial tension, is deactivated by being coated with the organic silane molecule 12 including an organic functional group or a fluoro group. Therefore, the porous film 1 is less likely to disintegrate during drying than in a case where the surface is not coated. Thus, the porous film 1 illustrated in FIG. 1 is obtained.

Next, description is given of a method of manufacturing the porous film 1 in which a plurality of nanoparticles 11 are coupled to each other by the cross-linking part 21 via the organic silane molecule 12.

### (Synthesis of Nanoparticle)

First, in the same manner as the above-described method of manufacturing the porous film 1 in which the plurality of nanoparticles 11 are directly coupled to each other by the cross-linking parts 21, the nanoparticle 11 (e.g., silica particle) is synthesized using the liquid phase method. It is preferable to select, as a precursor in the liquid phase method, a molecule represented by the above-mentioned general formula (7), which is able to form a three-dimensional polysiloxane skeleton (Si—O—Si) through a hydrolysis reaction and a condensation polymerization reaction. Examples of such a precursor include water glass (silicate soda (sodium silicate)) and an alkoxysilane molecule. The alkoxysilane molecule may be a molecule, in which some of alkoxy groups are substituted with non-hydrolyzable functional groups, and is no obstacle to the formation of the polysiloxane skeleton.

### (Surface Modification of Nanoparticle)

Next, the nanoparticles 11 are dispersed in a solvent to modify the surface. Here, instead of the surfactant molecule, the amino acid molecule or the macromolecule, the organic silane molecule 12 (silane coupling agent) represented by the following general formula (8) or general formula (9) is added to the dispersion liquid. After the addition of the silane coupling agent, heating is performed as needed. This causes the nanoparticle 11 (silica particle) and the organic silane molecule 12 to react with each other to form a covalent bond, thus deactivating the surface of the nanoparticle 11 and preventing aggregation of the nanoparticles 11. In addition, as in the present manufacturing method, in a case where the nanoparticle 11 is surface-coated with the organic silane molecule 12, the plurality of nanoparticles 11 are coupled to each other by the cross-linking part 21 via the organic silane molecule 12. Therefore, it is required for the organic silane molecule 12 represented by the following general formula (8) or general formula (9) to have the reactive functional group 13 in order to be covalently bonded to the cross-linking part 21. Examples of the reactive functional group 13 include a vinyl group, a methacrylic group, an acrylic group, a glycidyl group, a mercapto group, an amino group, a hydrosilyl group, a hydroxyl group, a carboxyl group, a cyano group, and an amino group.

(Chemical Formula 8)

R⁸_{X}Si(OR⁹)_{4·|X}·c (8)

(Chemical Formula 9)

R⁸_{X}SiCl_{4·|X}·c (9)

(R⁸ is any of a hydrogen atom, a vinyl group, an acryloxy group, a methacryloxy group, an aminopropyl group, a glycidoxypropyl group, and a mercaptopropyl group. R⁹ is any of a methyl group, an ethyl group, a propyl group, and an isopropyl group. X is an integer of 3 or less.)

(Cross-Linking between Nanoparticles)

Next, the nanoparticles 11 are cross-linked using a cross-linking agent including two or more reactive functional groups. A silane compound such as the above-described polyfunctional allyl (vinyl), polyfunctional thiol, polyfunctional (meth)acrylate or polyfunctional glycidyl is added as the cross-linking agent to the dispersion liquid in which the nanoparticles 11 are dispersed, with each surface being coated with the organic silane molecule 12. After the addition of the silane compound, heating or light irradiation is performed as needed. Thus, in the dispersion liquid, a cross-linking reaction with the organic functional group of the organic silane molecule 12 proceeds to form the porous film 1 having a three-dimensional structure. The dispersion liquid gradually loses its fluidity to be brought into a gel state. In a case where the cross-linking reaction is an organic reaction such as a radical reaction, cationic polymerization or anionic polymerization, an appropriate reaction initiator may be added.

### (Drying of Three-Dimensional Structure)

Finally, in the same manner as the above-described method of manufacturing the porous film 1 in which the plurality of nanoparticles 11 are directly coupled to each other by the cross-linking parts 21, the dispersion liquid brought into a gel state is dried to obtain the porous film 1. In a case where the nanoparticles 11 coated in advance with the organic silane molecule 12 are coupled to each other via the cross-linking part 21 as in the present manufacturing method, the reactive functional group 13, which has not been reacted, has hydrophobicity, and thus the above-described water-repellent step (step S104) is omitted. Thus, the porous film 1 illustrated in FIG. 1 is obtained.

### (1-3. Workings and Effects)

In the porous film 1 of the present embodiment, the plurality of nanoparticles 11, surface-coated with the organic silane molecule 12 including an organic functional group or a fluoro group, are coupled to each other via the cross-linking part 21. This prevents aggregation of the plurality of nanoparticles 11, thus suppressing growth of the particles. This is described below.

A water-repellent film is used as a protective sheet for anti-drip, anti-fouling, and anti-rust, as well as preventing adhesion of fingerprints, imparting lubricity, and maintaining a texture of a material. The water-repellent film is typically, for example, a coating such as a fluorine compound, silicone, a surfactant, or wax. Among those, in particular, a fluorine compound and silicone are each known as a water-repellent film with excellent water repellency and durability

Incidentally, the water repellency of the water-repellent film is improved by the unevenness of the surface. The aerogel described above is expected to be utilized as an antireflection film because of its low refractive index and its low dielectric constant. However, the transparency of the current aerogel is insufficient, and the low product quality such as generation of white turbidity or noises becomes an issue. This is due to the thickness of the skeleton of the aerogel.

The aerogel scatters light depending on the thickness of the skeleton, and the scattering intensity is proportional to the sixth power of the particle diameter, for example. The aerogel is manufactured, for example, as follows. First, a silica alkoxide precursor is dissolved in a solvent such as ethanol, and particles are grown by hydrolysis and condensation polymerization to obtain nanoparticles. Thereafter, the nanoparticles are copolymerized together to form a skeleton, and are gelled. The resulting wet gel is subjected to supercritical drying to remove the solvent, for example, to thereby obtain a porous aerogel. In the above-described manufacturing method, the particle growth proceeds also in the steps of the skeleton formation and the drying, thus increasing the thickness of the skeleton of the aerogel and lowering the transparency.

In contrast, in the present embodiment, the plurality of nanoparticles 11 are surface-coated with the organic silane molecule 12 including an organic functional group or a fluoro group, and the nanoparticles 11 are coupled to each other via the cross-linking part 21 including a silane compound, for example. This prevents aggregation of the plurality of nanoparticles 11 and suppress particle growth in the skeleton formation step and the drying step.

As described above, in the porous film 1 of the present embodiment, the plurality of nanoparticles 11, that are surface-coated with the organic silane molecule 12 including an organic functional group or a fluoro group, are coupled to each other via the cross-linking part 21, thus preventing aggregation of the plurality of nanoparticles 11. Thus, it is possible to provide the porous film 1 with high light transmittance and high water repellency.

In addition, in the present embodiment, before the plurality of nanoparticles 11 having the beaded skeleton constituting the porous film 1 are coupled to each other with a cross-linking agent, the surface is coated with an amphipathic molecule such as a surfactant molecule, an amino acid molecule, or a macromolecule, or an organic silane molecule. This makes it possible to prevent aggregation of the plurality of nanoparticles 11 in the cross-linking step and suppress particle growth. Thus, it is possible to provide the porous film 1 having higher transmittance.

Next, description is given of a modification example of the foregoing embodiment. Hereinafter, components similar to those in the foregoing embodiment are denoted by the same reference numerals, and descriptions thereof are omitted as appropriate.

### 2. Modification Example

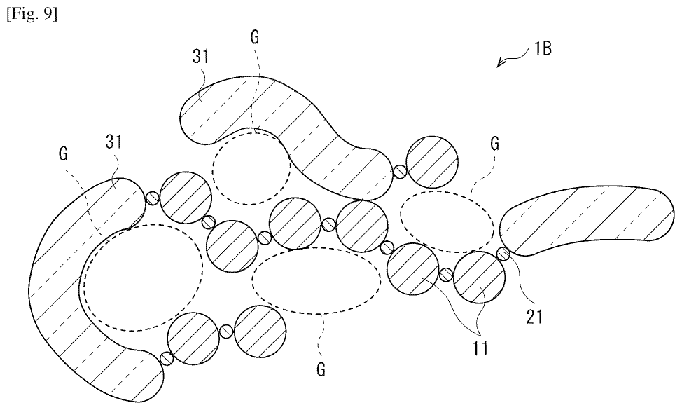

FIG. 8 schematically illustrates an example of a configuration of a porous film (a porous film 1A) according to a modification example of the present disclosure. In the same manner as the porous film 1 in the foregoing embodiment, the porous film 1A is used, for example, as an antireflection film and a protective sheet for anti-drip, anti-fouling, and anti-rust, as well as preventing adhesion of fingerprints, imparting lubricity, and maintaining a texture of a material. The porous film 1A of the present modification example differs from the foregoing embodiment in that a plurality of nanofibers 31 is used instead of the plurality of nanoparticles 11.

The nanofiber 31 is a fibrous material having a length of 100 times or more the diameter, for example, and is a silica nanofiber, for example. The average diameter (fÓ) of the nanofiber 31 is preferably, for example, 11 nm or less, and more preferably 7 nm or less. In the same manner as the nanoparticle 11, the nanofiber 31 includes the organic silane molecule 12 including an organic functional group or a fluoro group, or an organic functional group or a fluoro group. The nanofiber 31 is surface-coated with the organic silane molecule 12 including the reactive functional group 13, thus bringing the plurality of nanofibers 31 into a state of not being able to be covalently bonded to each other.

In the same manner as the foregoing embodiment, the plurality of nanofibers 31 are coupled to each other via the cross-linking part 21. The length of the cross-linking part 21 is preferably smaller than half (½) of the diameter (fÓ) of the nanofiber 31. This makes it possible to prevent aggregation of the plurality of nanofibers 31 inside the porous film 1A.

For example, the nanofiber 31 is able to form a silica nanofiber having a diameter of 5 nm to 10 nm by using an inverted micellar liquid crystal phase as a template (Literature 3 (W. C. Lai, L et al. J. Taiwan Inst. Chem. Eng. 2019, 99, 207-214)). In addition, for example, the nanofiber 31 is able to form a twisted rod-like silica nanofiber by utilizing self-assembly of aminopropyltrimethoxy silane (Literature 4 (Y. Kaneko et al. Chem. Mater. 2004, 16, 3417-3423)).

It is to be noted that above-described manufacturing method is exemplary, and this is not limitative as long as a the nanofiber 31 having a diameter of 11 nm or less is finally obtained.

As for the surface modification of the nanofiber 31, the cross-linking between the nanofibers 31 using a cross-linking agent, and the water repellency and drying of the surface of the nanofiber 31, similar methods can be used to the above-described methods for the surface modification of the nanoparticle 11, the cross-linking between the nanoparticles 11 using a cross-linking agent, and the drying thereof.

It is to be noted that FIG. 8 illustrates an example of the porous film 1A configured only by the nanofiber 31, but this is not limitative. For example, as in a porous film 1B illustrated in FIG. 9, the nanoparticle 11 and the nanofiber 31 may be present in a mixed manner. Also in such a case, the nanoparticles 11 are coupled to each other, the nanofibers 31 are coupled to each other, and the nanoparticle 11 and the nanofiber 31 are coupled to each other, via the cross-linking part 21 described above.

As described above, in the porous films 1A and 1B of the present modification example, some or all of the nanoparticles 11 are replaced with the nanofibers 31. The surface thereof is coated with the organic silane molecule 12 including an organic functional group or a fluoro group, or the organic silane molecule 12 including an organic functional group or a fluoro group and further the reactive functional group 13. The nanoparticle 11 and the nanofiber 31 are coupled to each other, or the nanofibers 31 are coupled to each other, for example, via the cross-linking part 21 including a silane compound. This makes it possible to prevent aggregation of the plurality of nanoparticles 11, between the plurality of nanofibers 31, or between the nanoparticle 11 and the nanofiber 31, and thus to suppress growth of the skeleton. Note that the plurality of nanoparticles 11 and the plurality of nanofibers 31 constitute the porous film 1A and the porous film 1B. Thus, it is possible to obtain effects similar to those of the foregoing embodiment.

Although the description has been given hereinabove of the present disclosure with reference to the embodiment and modification example, the present disclosure is not limited to the foregoing embodiment and the like, and may be modified in a wide variety of ways. For example, the foregoing embodiment or the like exemplifies a silica particle as the nanoparticle 11 and a silica nanofiber as the nanofiber 31, but this is not limitative. It may also be possible to use a nanoparticle or nanofiber including an inorganic oxide, an inorganic nitride, an inorganic carbide or an organic matter. In addition, the porous film (e.g., porous film 1) of the present disclosure may be configured by, for example, a plurality of types of nanoparticles and/or nanofibers for which the above-described materials are appropriately selected.

In addition, the foregoing embodiment and the like exemplify, as application examples of the porous film 1, an antireflection film and a protective sheet for anti-drip, anti-fouling, and anti-rust, as well as preventing adhesion of fingerprints, imparting lubricity, and maintaining a texture of a material. However, the porous film 1 or the like of the present disclosure may be used, as a functional member other than the protective sheet and the antireflection film, for other electronic apparatuses and the like. For example, employing a bulk structure allows for applications similar to those of typical porous materials, such as a heat insulating material; an adsorbent of an odorous component, bacteria, and virus; a hygroscopic material that controls air humidity to be constant; and sound-absorbing material that prevents a sound wave from traveling. In addition, the porous film 1 is able to be used for an application requiring transparency, and thus is also applicable to a photocatalyst, artificial photosynthesis, a structural material for an electronic apparatus such as a solar cell or a semiconductor, as well as to a low dielectric constant film, or the like.

It is to be noted that the effects described herein are merely exemplary and should not be limited thereto, and may further include other effects.

It is to be noted that the present technology may also have the following configurations. According to the present technology of the following configurations, the plurality of nanoparticles or the plurality of nanofibers, that are surface-coated with the organic silane molecule including an organic functional group or a fluoro group, are coupled to each other via the cross-linking part. This prevents aggregation of the plurality of nanoparticles or the plurality of nanofibers, and suppresses growth of particles. Thus, it is possible to provide a porous film with high light transmittance and high water repellency.

(1) A nanomaterial structure comprising:

a nanomaterial including a nanomaterial surface;

an organic silane compound provided on the nanomaterial surface; and

a nanomaterial cross-linking part, wherein the nanomaterial is cross-linked with the nanomaterial cross-linking part.

(2)

The nanomaterial structure according to (1), wherein the nanomaterial is cross-linked with the nanomaterial cross-linking part, directly or indirectly, via a covalent bond.

(3)

The nanomaterial structure according to (1) or (2), wherein the nanomaterial cross-linking part includes an organic material or an inorganic material covalently bonded to the nanomaterial.

(4)

The nanomaterial structure according to any one of (1) to (3), wherein the nanomaterial cross-linking part includes a silane compound.

(5)

The nanomaterial structure according to any one of (1) to (4), wherein the nanomaterial cross-linking part is bonded to the nanomaterial at one or two locations.

(6)

The nanomaterial structure according to any one of (1) to (4), wherein the nanomaterial cross-linking part is bonded indirectly to the nanomaterial via the organic silane compound provided on the nanomaterial surface.

(7)

The nanomaterial structure according to any one of (1) to (6), wherein a length of the nanomaterial cross-linking part is smaller than ½ of an average particle diameter of the nanomaterial.

(8)

The nanomaterial structure according to any one of (1) to (7), wherein an average particle diameter of the nanomaterial is 11 nm or less.

(9)

The nanomaterial structure according to any one of (1) to (7), wherein an average particle diameter of the nanomaterial is 7 nm or less.

(10)

The nanomaterial structure according to any one of (1) to (9), wherein the nanomaterial includes at least one of a plurality of nanoparticles, nanofibers or nanosheets having a surface coated with the organic silane compound and that are cross-linked with the nanomaterial cross-linking part.

(11)

The nanomaterial structure according to any one of (1) to (10), wherein the organic silane compound includes one or more of an organic functional group or a fluoro group.

(12)

A porous film comprising:

a nanomaterial including a nanomaterial surface;

an organic silane compound provided on the nanomaterial surface; and

a nanomaterial cross-linking part, wherein the nanomaterial is cross-linked with the nanomaterial cross-linking part.

(13)

The porous film according to (12), wherein the porous film is an antireflection film or a protective sheet.

(14)

A porous material comprising:

a nanomaterial including a nanomaterial surface;

an organic silane compound provided on the nanomaterial surface; and

a nanomaterial cross-linking part, wherein the nanomaterial is cross-linked with the nanomaterial cross-linking part.

(15)

The porous material according to (14), wherein the porous material is a heat insulating material, an adsorbent material, a hygroscopic material, a sound-absorbing material, a transparent material including a photocatalyst material, an artificial photosynthesis material, a material for an electronic apparatus including a solar cell material, a semiconductor material, or a low dielectric constant film material.

(16)

A method of manufacturing a material comprising:

providing a nanomaterial including a nanomaterial surface; and

providing an organic silane compound on the nanomaterial surface to form a coated nanomaterial.

(17)

The method according to (16) further comprising:

providing a cross-linking agent; and

forming a nanomaterial cross-linked structure by cross-linking the coated nanomaterial with the cross-linking agent.

(18)

The method according to (17), further comprising:

drying the nanomaterial cross-linked structure.

(19)

The method according to (17), further comprising:

forming a porous film or a porous material from the nanomaterial cross-linked structure.

(20)

The method according to (19), wherein the porous film or the porous material is an antireflection film, a protective sheet, a heat insulating material, an adsorbent material, a hygroscopic material, a sound-absorbing material, or a transparent material including a photocatalyst material, an artificial photosynthesis material, a material for an electronic apparatus including a solar cell material, a semiconductor material, or a low dielectric constant film material.

(21)

A method of manufacturing a nanomaterial structure comprising:

providing a nanomaterial including a nanomaterial surface and an organic silane compound provided on the nanomaterial surface;

providing a cross-linking agent; and

forming the nanomaterial structure by cross-linking the nanomaterial with the cross-linking agent.

(22)

A method of manufacturing a nanomaterial structure comprising:

forming the nanomaterial structure by drying a nanomaterial cross-linked structure, wherein the nanomaterial cross-linked structure includes a nanomaterial including a nanomaterial surface and an organic silane compound provided on the nanomaterial surface, and wherein the nanomaterial is cross-linked with a cross-linking agent.

(23)

A method of manufacturing a product comprising:

forming the product from a nanomaterial structure, wherein the nanomaterial structure includes a nanomaterial including a nanomaterial surface and an organic silane compound provided on the nanomaterial surface, wherein the nanomaterial is cross-linked with a cross-linking agent, and wherein the nanomaterial structure has been dried.

(24)

A porous film including:

a plurality of nanoparticles or a plurality of nanofibers that are surface-coated with an organic silane molecule including an organic functional group or a fluoro group; and

a cross-linking part that couples the plurality of nanoparticles or the plurality of nanofibers to each other.

(25)

The porous film according to (24), in which the nanoparticles or the nanofibers and the cross-linking part form a covalent bond.

(26)

The porous film according to (24) or (25), in which the cross-linking part includes an organic matter or an inorganic matter covalently bonded directly to the nanoparticles or the nanofibers.

(27)

The porous film according to (24) or (25), in which the cross-linking part includes an organic matter or an inorganic matter covalently bonded to the nanoparticles or the nanofibers via a silyl group.

(28)

The porous film according to any one of (24) to (27), in which the cross-linking part is bonded to the nanoparticles or the nanofibers at one or two locations.

(29)

The porous film according to any one of (24) to (28), in which a length of the cross-linking part is smaller than ½ of an average particle diameter of the plurality of nanoparticles.

(30)

The porous film according to any one of (24) to (28), in which a length of the cross-linking part is smaller than ½ of an average diameter of the plurality of nanofibers.

(31)

The porous film according to any one of (24) to (29), in which the average particle diameter of the plurality of nanoparticles is 11 nm or less.

(32)

The porous film according to any one of (24) to (29), in which the average particle diameter of the plurality of nanoparticles is 7 nm or less.

(33)

The porous film according to any one of (24) to (28) or (30), in which the average diameter of the plurality of nanofibers is 11 nm or less.

(34)

The porous film according to any one of (24) to (33), in which the porous film includes both of the plurality of nanoparticles and the plurality of nanofibers, and

the nanoparticles and the nanofibers are partially coupled via the cross-linking part.

(35)

A method of manufacturing a porous film, the method including:

coupling a plurality of nanoparticles or a plurality of nanofibers to each other via a cross-linking part including a cross-linking agent by adding the cross-linking agent; and modifying surfaces of the plurality of nanoparticles or the plurality of nanofibers by adding an organic silane molecule including an organic functional group or a fluoro group.

(36)

The method of manufacturing the porous film according to (35), in which, before the coupling between the plurality of nanoparticles or between the plurality of nanofibers, an amphipathic molecule or an organic silane molecule is added to a dispersion liquid, in which the plurality of nanoparticles or the plurality of nanofibers are dispersed, and is adsorbed to the surfaces of the plurality of nanoparticles or the plurality of nanofibers.

(37)

A structure including:

a plurality of nanoparticles or a plurality of nanofibers that are surface-coated with an organic silane molecule including an organic functional group or a fluoro group; and a cross-linking part that couples the plurality of nanoparticles or the plurality of nanofibers to each other.

The present technology relates to Goal 13·gCLIMATE ACTION·h and Goal 07 ·gAffordable and Clean Energy·h of the SDGs (Sustainable Development Goals) adopted at the United Nations Summit in 2015, given the structure and characteristics of the nanomaterial structure including a nanomaterial and applications thereof. For example, the nanomaterial structure is transparent and has a heat insulation property that makes it ideal for use (e.g., as applied to a surface) for any suitable glass material (e.g., a window, such as, a window for residential, commercial, and vehicle use (e.g., a car) for energy efficiency purpose. In conventional glass material, there is a problem that the energy consumption for indoor air cooling/heating purpose increases due to a large amount of heat flowing in/out of the window during indoor air heating/cooling process. By using the nanomaterial structure of the present technology in combination with a suitable glass material (e.g.,window), less energy consumption should be required for indoor air heating/cooling purpose thereby further contributing to a reduction of CO₂ emissions from power generation that utilize combustion of fossil fuels. Further, for example, the nanomaterial structure of the present technology can be utilized as a transparent plate of a solar collector to enhance the energy efficiency (e.g., heat collection efficiency) of the solar collector, and thus contributing to a reduction of energy consumption derived from fossil fuels and thereby a reduction in CO₂ emissions.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1, 1A, 1B porous film

11 nanoparticle

12 organic silane molecule

13 reactive functional group

21 cross-linking part

31 nanofiber

1. A nanomaterial structure comprising:
a nanomaterial including a nanomaterial surface;
an organic silane compound provided on the nanomaterial surface; and
a nanomaterial cross-linking part, wherein the nanomaterial is cross-linked with the nanomaterial cross-linking part.

2. The nanomaterial structure according to claim 1, wherein the nanomaterial is cross-linked with the nanomaterial cross-linking part, directly or indirectly, via a covalent bond.

3. The nanomaterial structure according to claim 2, wherein the nanomaterial cross-linking part includes an organic material or an inorganic material covalently bonded to the nanomaterial.

4. The nanomaterial structure according to claim 3, wherein the nanomaterial cross-linking part includes a silane compound.

5. The nanomaterial structure according to claim 4, wherein the nanomaterial cross-linking part is bonded to the nanomaterial at one or two locations.

6. The nanomaterial structure according to claim 4, wherein the nanomaterial cross-linking part is bonded indirectly to the nanomaterial via the organic silane compound provided on the nanomaterial surface.

7. The nanomaterial structure according to claim 1, wherein a length of the nanomaterial cross-linking part is smaller than ½ of an average particle diameter of the nanomaterial.

8. The nanomaterial structure according to claim 1, wherein an average particle diameter of the nanomaterial is 11 nm or less.

9. The nanomaterial structure according to claim 1, wherein an average particle diameter of the nanomaterial is 7 nm or less.

10. The nanomaterial structure according to claim 1, wherein the nanomaterial includes at least one of a plurality of nanoparticles, nanofibers or nanosheets having a surface coated with the organic silane compound and that are cross-linked with the nanomaterial cross-linking part.

11. The nanomaterial structure according to claim 10, wherein the organic silane compound includes one or more of an organic functional group or a fluoro group.

12. A porous film comprising:
a nanomaterial including a nanomaterial surface;
an organic silane compound provided on the nanomaterial surface; and
a nanomaterial cross-linking part, wherein the nanomaterial is cross-linked with the nanomaterial cross-linking part.

13. The porous film according to claim 12, wherein the porous film is an antireflection film or a protective sheet.

14. A porous material comprising:
a nanomaterial including a nanomaterial surface;
an organic silane compound provided on the nanomaterial surface; and
a nanomaterial cross-linking part, wherein the nanomaterial is cross-linked with the nanomaterial cross-linking part.

15. The porous material according to claim 14, wherein the porous material is a heat insulating material, an adsorbent material, a hygroscopic material, a sound-absorbing material, a transparent material including a photocatalyst material, an artificial photosynthesis material, a material for an electronic apparatus including a solar cell material, a semiconductor material, or a low dielectric constant film material.

16. A method of manufacturing a material comprising:
providing a nanomaterial including a nanomaterial surface; and
providing an organic silane compound on the nanomaterial surface to form a coated nanomaterial.

17. The method according to claim 16 further comprising:
providing a cross-linking agent; and
forming a nanomaterial cross-linked structure by cross-linking the coated nanomaterial with the cross-linking agent.

18. The method according to claim 17, further comprising:
drying the nanomaterial cross-linked structure.

19. The method according to claim 17, further comprising:
forming a porous film or a porous material from the nanomaterial cross-linked structure.

20. The method according to claim 19, wherein the porous film or the porous material is an antireflection film, a protective sheet, a heat insulating material, an adsorbent material, a hygroscopic material, a sound-absorbing material, or a transparent material including a photocatalyst material, an artificial photosynthesis material, a material for an electronic apparatus including a solar cell material, a semiconductor material, or a low dielectric constant film material.

21. A method of manufacturing a nanomaterial structure comprising:
providing a nanomaterial including a nanomaterial surface and an organic silane compound provided on the nanomaterial surface;
providing a cross-linking agent; and
forming the nanomaterial structure by cross-linking the nanomaterial with the cross-linking agent.

22. A method of manufacturing a nanomaterial structure comprising:
forming the nanomaterial structure by drying a nanomaterial cross-linked structure, wherein the nanomaterial cross-linked structure includes a nanomaterial including a nanomaterial surface and an organic silane compound provided on the nanomaterial surface, and wherein the nanomaterial is cross-linked with a cross-linking agent.

23. A method of manufacturing a product comprising:
forming the product from a nanomaterial structure, wherein the nanomaterial structure includes a nanomaterial including a nanomaterial surface and an organic silane compound provided on the nanomaterial surface, wherein the nanomaterial is cross-linked with a cross-linking agent, and wherein the nanomaterial structure has been dried.
